(19) United States
(12) Patent Application Publication
(10) Pub. No.: US 2015/0081437 A1
(43) Pub. Date: Mar. 19, 2015

(54) SYSTEMS AND METHODS FOR MANAGING CUSTOMER ENGAGEMENTS

(71) Applicant: Capillary Technologies International Pte Ltd., Singapore (SG)

(72) Inventors: Krishna Kumar Mehra, Kolkata (IN); Prasun Kumar, Bangalaore (IN); Prakhar Verma, Jharkhand (IN); Abhilash L. Lakkur, Bangalore (IN)

(21) Appl. No.: 14/479,194

(22) Filed: Sep. 5, 2014

(30) Foreign Application Priority Data
Sep. 18, 2013 (IN) 4190/CHE/2013

(51) Int. Cl. G06Q 30/02

(52) U.S. Cl. CPC G06Q 30/0255
USPC 705/14.53

(57) ABSTRACT

A system for managing customer engagements of a client is provided. The system includes an event tracker configured to track at least one of transactional data and customer profile data of a plurality of customers of the client and a customizable rule engine configured to dynamically generate one or more customized rules using parameters associated with at least one of the transactional data and the customer profile data. The system also includes a customer event management module coupled to the event tracker and to the customizable rule engine, wherein the customer event management module is configured to analyze the transactional data and the d customer profile data for each customer to select one or more applicable rules and to apply the selected rules to generate one or more customized offers for the respective customer. The system further includes a customer engagement module configured to execute instructions for transmitting the one or more customized offers to the respective customer.

### BACKGROUND

A number of customer purchase transactions occur on a daily basis in the retail segments. The customer purchase transactions are typically processed using offline and online transaction channels. Certain purchase transactions that occur on a day-to-day basis are recorded in computer-based databases. Such databases can be mined and data can be analyzed for trends, statistics, among other parameters.

Various forms of customer offers and rewards are currently being used by retailers. For example, the retailers may offer coupons, discounts, mail-in rebates to the customers. However, most of these offers and rewards are untargeted.

Certain systems record information such as purchase history and demographical data of customers over a period of time. Such information can be used for predicting customer purchase behaviors and for generating customer offers. However, given the dynamic nature of the retail segment it can be difficult to track and analyze customer activity over different transactional and other channels. Further, it can be tedious to analyze activities over these different channels to generate the customer offers. In some systems, offers and/or incentives are generated based on such limited information and the offers may not correspond to actual purchase behaviors of the customers and may not have substantial affect on interactions of the customers with the businesses. Moreover, certain systems for tracking of customer transactional and other activities and generating offers are not scalable with time and do not cater to multiple clients.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

According to some examples of the present disclosure, a system for managing customer engagements of a client is provided. The system includes, an event tracker configured to track at least one of transactional data and customer profile data of a plurality of customers of the client and a customizable rule engine configured to dynamically generate one or more customized rules using parameters associated with at least one of the transactional data and the customer profile data. The system also includes a customer event management module coupled to the event tracker and to the customizable rule engine, wherein the customer event management module is configured to analyze the transactional data and the customer profile data for each customer to select one or more applicable rules and to apply the selected rules to generate one or more customized offers for the respective customer. The system further includes a customer engagement module configured to execute instructions for transmitting the one or more customized offers to the respective customer.

According to additional examples of the present disclosure, a computer-implemented method for managing customer engagements of a client is provided. The method includes tracking at least one of transactional data and customer profile data of a plurality of customers of the client and dynamically generating one or more customized rules using parameters associated with at least one of the transactional data and the customer profile data. The system also includes analyzing the transactional data and customer profile data of each customer to identify one or more applicable rules for the respective customer and applying the identified one or more rules to generate one or more customized offers for the respective customer. The system further includes transmitting the one or more customized offers to the respective customer.

According to still further examples of the present disclosure, a system for managing customer engagements of a client is provided. The system includes an event tracker configured to track at least one of transactional data and customer profile data of a plurality of customers of the client, wherein the event tracker is further configured to generate aggregates of one or more customer attributes for the customers. The system also includes a customizable rule engine configured to dynamically generate one or more customized rules using parameters associated with at least one of the transactional data, the customer profile data and the generated aggregates. The system further includes a customer event management module coupled to the event tracker and to the customizable rule engine, wherein the customer event management module is configured to analyze the transactional data, the customer profile data and the generated aggregates for each customer to select one or more applicable rules and to apply the selected rules to generate one or more customized offers and/or perform one or more customer actions for the respective customer.

### BRIEF DESCRIPTION OF THE FIGURES

FIG. 1 is a schematic diagram illustrating components of an example system for managing customer engagements of a client.

FIG. 2 is an illustration of an example process for managing customer engagements of a client.

FIG. 3 illustrates an example implementation of a rule tree for customized rules generated by a customizable rule engine such as the rule engine of the example system of FIG. 1.

FIG. 4 illustrates an example implementation for generating customized rules such as using the example system 100 of FIG. 1.

FIG. 5 illustrates an example package identification structure of the customer packages loaded in an example system such as system of FIG. 4.

FIG. 6 is a block diagram illustrating an example computing device that is arranged for managing customer engagements of a client.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Example embodiments of the present disclosure are generally directed to techniques for managing customer engagements of a client. The customer activity such as transactional data and customer profile data of each customer of the client are dynamically tracked and customized offers and/or customized actions are generated. Further, such customized offers and/or customized actions are delivered to the respective customers via real-time communication channels. Moreover, the embodiments of the present technique provide a system for managing customer engagements that is scalable and can cater to multiple end points. The proposed system further facilitates tracking activities of customers over a period of time and accordingly incentivizing the respective customers.

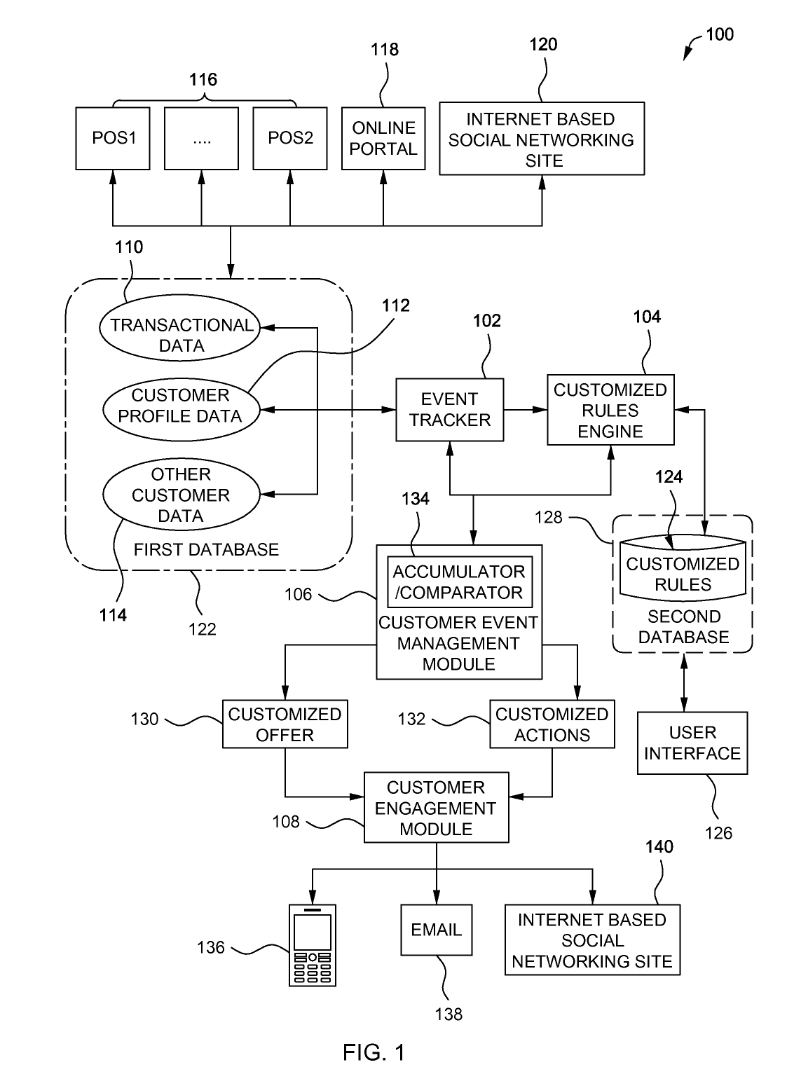

FIG. 1 is a schematic diagram illustrating components of an example system 100 for managing customer engagements of a client arranged in accordance with at least some embodiments of the present disclosure. The system 100 includes an event tracker 102, a customizable rule engine 104, a customer event management module 106, and a customer engagement module 108. In certain embodiments, at least one of the event tracker 102, the customizable rule engine 104, the customer event management module 106, and the customer engagement module 108 is a cloud-based resource. The event tracker 102 is configured to track at least one of transactional data 110, customer profile data 112 and other customer data 114 of a plurality of customers of a client. The event tracker 102 is configured to track such data over a period of time. For example, the event tracker can track the data over a pre-determined time period (e.g., for 100 days) specified by a user of the system 100. In another example, the event tracker 102 is configured to track the data over a recurring time period (say every month of an year).

Examples of transactional data 110 includes, but are not limited to, data regarding purchases made by the customers, registration of the customers, purchase location of the customers, payment modes used by the customers, redemption of one or more offers provided to the customers by the client, or combinations thereof. In one example embodiment, transactional data 110 includes data corresponding to transactions made by the plurality of customers at one or more point-of-sale terminals (generally represented by reference numerals 116) of a client store. In another example embodiment, transactional data 110 includes data corresponding to transactions made by the plurality of customers using at least one online sale portal 118.

Examples of the customer profile data 112 include, but are not limited to, data related to age bands of the customers, location of the customers, names of the customers, client loyalty points of the customers, loyalty tiers of the customers, lifetime points of the customers, lifetime purchase value of the plurality of customers, number of days since last visit of the customers at an offline/online store, number of total visits of the customers at a store, average number of items bought per purchase by the customers, or combinations thereof.

In another example, the customer profile data 112 includes data associated with activities of the plurality of customers on an internet-based social network 120. For example, the customer profile data can include statistical data such as number of likes of a particular web page of the client on a social networking site, posts related to products of the client on a social networking site and so forth. Examples of the other customer data 114 include, but are not limited to, product campaign internet web pages visited by the customers, customer feedback related to products of the client, or combinations thereof. In certain embodiments, the event tracker 102 is further configured to group the transactional data 110, the customer profile data 112 and the other data 114 for each customer to form a customer package that may be used by the customer event management module 106 to generate one or more customized offers for the respective customer.

In the illustrated embodiment, the system 100 includes a first database 122 configured to store the transactional data 110, the customer profile data 112 and the other customer data 114 of the plurality of customers. In some examples, the event tracker 102 is further configured to track the transactional data 110 for one or more of the plurality of customers over a period of time.

In some examples, the event tracker 102 is further configured to track attributes related to products and/or services offered by the client. Examples of such attributes include, but are not limited to, a category of a stock keeping unit (SKU), quantity of the SKU, average number of SKUs sold over a period of time, or combinations thereof. In some example embodiments, the event tracker 102 is further configured to generate aggregates of one or more customer attributes for each customer of the client. For example, the event tracker 102 can generate stock keeping unit (SKU) aggregates over individual items of the store and related attributes. Examples of other attributes include, but are not limited to, color of a purchased product, category/sub-category of a product, brand of a product or combinations thereof. In another example embodiment, the generated aggregates include, but are not limited to, total spend on a product by the customer over a period of time, number of products purchased by the customer, number of distinct instances when the customer purchased a product, or combinations thereof.

In the illustrated embodiment, the customizable rule engine 104 is configured to dynamically generate one or more customized rules 124 using parameters associated with at least one of the transactional data 110, the customer profile data 112, the other profile data 114 and the generated aggregates of the customer attributes. The one or more customized rules 124 generated by the customizable rule engine 104 are configurable by a user through a user interface 126. In some examples, the one or more customized rules 124 generated by the customizable rule engine 104 are stored in a second database 128.

The customer event management module 106 is coupled to the event tracker 102 and to the customizable rule engine 104. The customer event management module 106 is configured to analyze the transactional data 110, the customer profile data 112 and the generated aggregates for each customer to select one or more applicable rules from the stored rules 124 and to apply the selected rules to generate one or more customized offers 130 and/or customized actions 132 for the respective customer.

Examples of the customized offers 130 include, but are not limited to, product offers, discount coupons, award points, loyalty slab movement of the customer, or combinations thereof. Examples of the customized actions 134 include, but are not limited to, posts on social networking sites, offer related messages on social networking sites, feedback forms on products and or/services of the client, push messages on a mobile device of the customer, loading offers onto customer devices, loading offers onto customer wallet, or combinations thereof.

In certain examples, activity of the respective customer on internet-based social networks for each customer 110 is tracked by the event tracker 102 and data related to such activity is used to select the applicable customized rules for the respective customer. In this example, the customer event management module 106 includes an accumulator and/or comparator 134 configured to compare the tracked data described above with pre-determined thresholds to select one or more applicable rules for the respective customer.

The customer engagement module 108 is configured to execute instructions for transmitting the one or more customized offers 130 to the respective customer 110. The customer engagement module 108 is further configured to execute instructions to perform one or more customer actions. In some example embodiments, the customer engagement module 108 is configured to transmit the one or more customized offers 130 to the respective customer using a short message services (sms) on a mobile device 136 of the customer, via electronic mail (email) 138, posts on an internet based social networking site 140, direct mailings, or combinations thereof.

It should be noted that the above arrangement of the components is purely illustrative and a variety of other arrangements and components may be envisaged. The present technique may facilitate dynamic tracking of customer activity for any number of clients in order to respond to the customers in a customized manner.

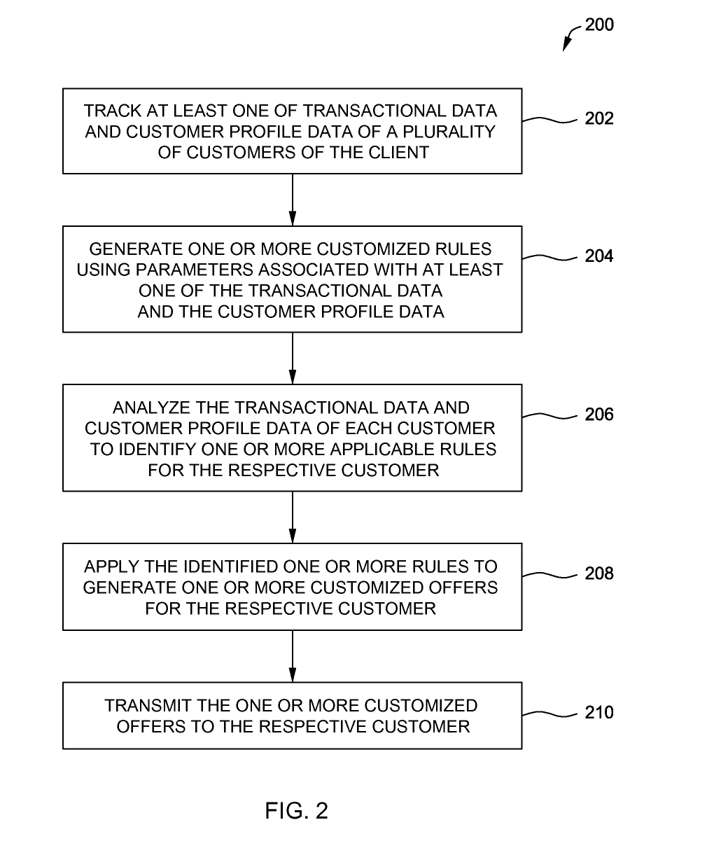

Referring now to FIG. 2, an illustration of an example process for managing customer engagements of a client is provided. At block 202, at least one of the transactional data and the customer profile data of a plurality of customers of the client is tracked. In one embodiment, the tracking of at least one of the transactional data and the customer profile data includes obtaining data associated with offline transactions of the customers, online transactions of customers, activities of the customers on social networking sites, or combinations thereof. The transactional data and the customer profile data may be tracked in real-time using a event tracker. In certain embodiments, such data may be tracked for a period of time and stored in a database. The time period for tracking such data may be user configurable.

Examples of transactional data includes, but are not limited to, data regarding purchases made by the customers, registration of the customers, purchase location of the customer, payment modes used by the customer, redemption of one or more offers provided to the customers by the client, or combinations thereof. In one example embodiment, transactional data includes data corresponding to transactions made by the plurality of customers at one or more point-of-sale terminals of a client store.

Examples of customer profile data include, but are not limited to, data related to age bands of the customers, location of the customers, names of the customers, client loyalty points of the customers, loyalty tiers of the customers, lifetime points of the customers, lifetime purchase value of the customers, day since last visit of the customers at an offline/online store, number of total visits of the customers at a store, average number of items bought per purchase by the customers, or combinations thereof.

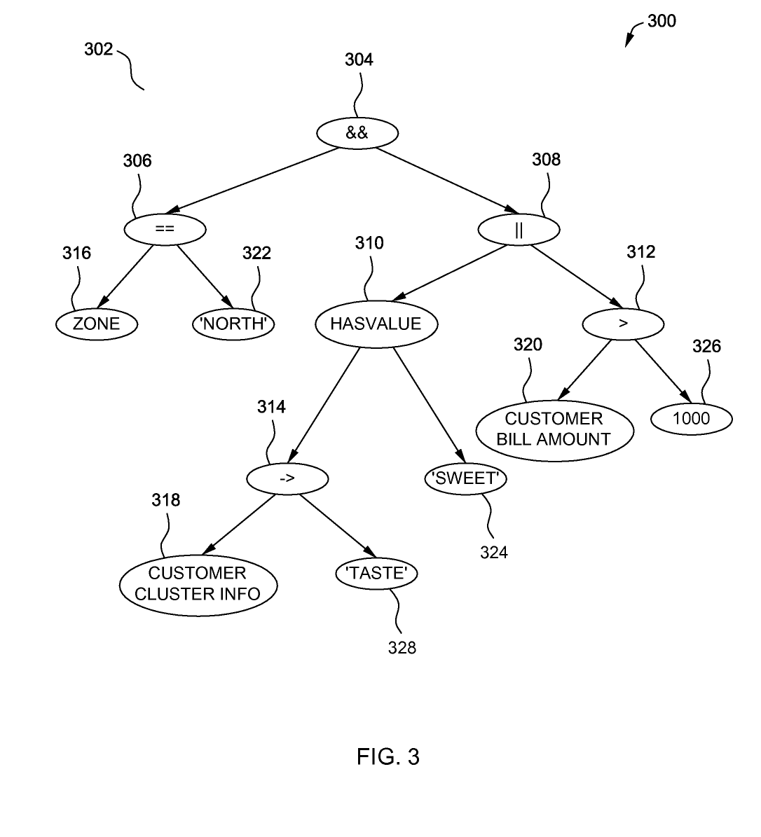

At block 204, one or more customized rules are dynamically generated using parameters associated with at least one of the transactional data and the customer profile data using a customizable rule engine. The one or more customized rules generated by the customizable rule engine can be configurable by a user of the system. In one example embodiment, the customized rules include a plurality of expressions. Further, each expression includes facts and operators represented in an infix tree form that is evaluated to a certain value. The expressions can be applied recursively to form a rule tree and the rule tree is evaluated to either a Boolean or an enumeration value. The rule tree will be described in a greater detail below with reference to FIG. 3.

At block 206, the transactional data and the customer profile data of each customer are analyzed to identify one or more applicable rules for the respective customer. In one example embodiment, the transactional data and the customer profile data of each customer are evaluated to determine whether the respective customer qualifies for receiving offers from the client. Moreover, one or more applicable rules are identified for the customer when the respective customer qualifies for receiving the offers from the client.

Examples of the customized offers include, but are not limited to, product offers, discount coupons, award points, loyalty slab movement of the customer, or combinations thereof. In some other embodiments, the transactional data and the customer profile data of each customer are analyzed to identify one or more customized actions for the customers. For example, customized actions may include, but are not limited to, posts on social networking sites, offer related messages on social networking sites, feedback forms related to products and or/services of the client, push messages on a mobile device of the customer, loading offers onto customer devices, loading offers onto customer wallet, or combinations thereof.

At block 208, the identified one or more rules are applied to generate one or more customized offers for the respective customer. The one or more customized offers are generated using the customer event management module that collates various decisions made by the respective customer over a period of time by tracking each of the customer related events. The customer event management module can compare the tracked data such as the transactional data and the customer profile data with pre-determined thresholds to select one or more applicable rules for the respective customer. In certain embodiments, aggregates of one or more customer attributes for each customer of the client. Again, such aggregates may be analyzed by the customer event management module and generation of customized offers and/or customized actions may be triggered based on such aggregates. It should be noted that different types of data related to customer transactions and customer activity may be tracked and analyzed to generate the customized offers and customized actions. In certain embodiments, the tracked data may be manipulated such as using Boolean operators to generate the customized offers and customized actions.

Further, at block 210, the one or more customized offers are transmitted to the respective customer. In some example embodiments, the customized offers are sent to the customer using short message service (sms), electronic mail (email), or combinations thereof. Here, a customer engagement module can be used to execute instructions for transmitting the one or more customized offers to the respective customer. The instructions can include relevant information required to transmit the one or more customized offers to the respective customer. For example, for an instruction related to issuing a discount coupon, the instruction includes a coupon series identifier, customer identifier, an amount of the coupon, templates for the coupon, or combinations thereof.

Referring now to FIG. 3, an example implementation of a rule tree 300 for customized rules generated by a customizable rule engine such as rule engine 104 of the example system 100. In this example embodiment, the rule tree includes an expression 302 depicted as below:

(customer.registerStore.zone==‘North’ && (customer.clusterInfo (‘taste’).hasValue(‘sweet’))∥customer.bill.amount>1000)) (1)

As illustrated, the rule tree 300 includes a plurality of operators such as represented by reference numerals 304, 306, 308, 310, 312, 314 and a plurality of facts such as represented by reference numerals 316, 318, 320. In this embodiment, the rule tree 300 further includes a plurality of constants 322, 324, 326 and 328. In one example embodiment, a condition expression is formed by representing the fact on a left hand side (LHS) and the constant on a right hand side (RHS) with an operator in between. In another example embodiment, both the LHS and the RHS can include an expression.

In this example, the operator 314 is used as a dereferencing operator wherein the facts are complex facts and may need other information before they can be evaluated. Similarly, the operator 310 is an operation defined on the enumeration type. The expression 302 is evaluated using a preorder traversal to make sure that the runtime evaluation of expression is relatively faster. The expression 302 is evaluated to a certain value and the associated actions are performed. The actions generate a set of instructions as their output that includes relevant information required to carry out certain operations.

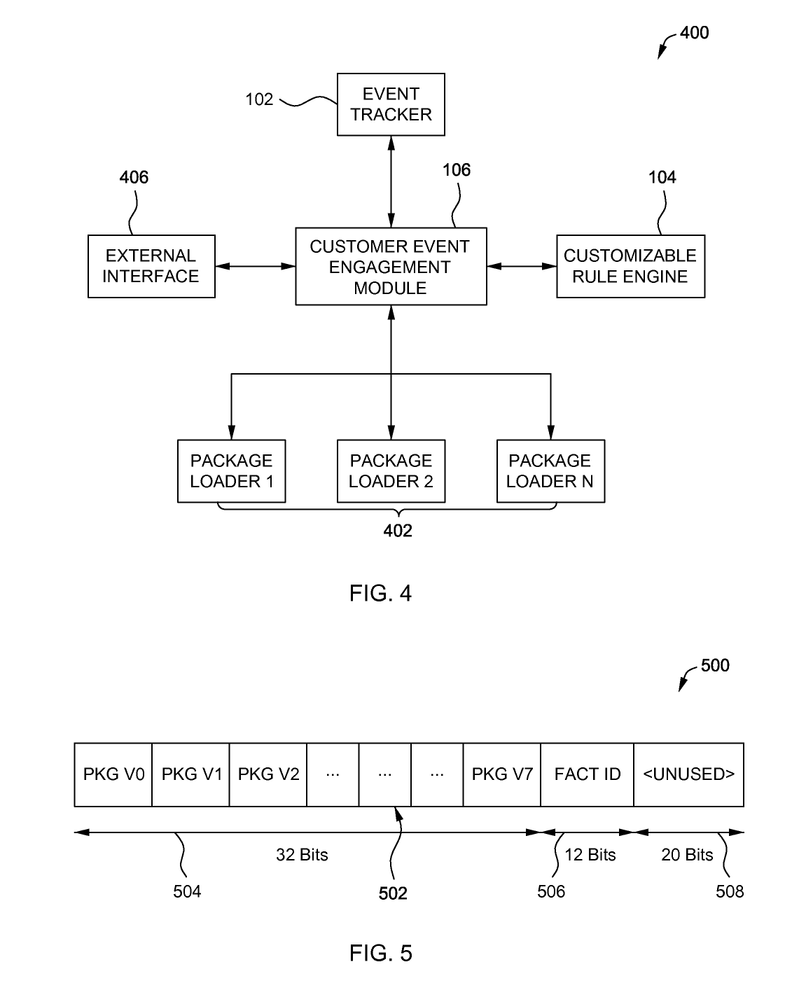

Referring now to FIG. 4, an example implementation 400 for generating customized rules such as using the example system 100 of FIG. 1. The system 400 includes the event tracker 102, the customizable rule engine 104, and the customer event management module 106. In the illustrated embodiment, the system 400 also includes a one or more package loaders (generally represented by reference numeral 402) configured to load a customer package (not shown). As discussed previously, the customer package 404 includes a stack of data associated with a customer. Such data may include transactional data, customer profile data and other customer data for each customer. In certain examples, the event tracker 102 can be configured to group such data to form the customer package. Further, the system 400 further includes an external interface 406 accessible by a user to communicate with the customer event management module 106. For example, the external interface 406 may be used by a client to provide additional customer packages to the system 400.

In operation, the event tracker 102 tracks at least one of the transactional data 110 and the customer profile data 112 of a plurality of customers of the client and groups such data to form the customer data package for each customer. The customer event management module 106 analyzes the customer data package and/or activity of the respective customer on internet-based social networks for each customer to select one or more applicable customized rules from the customizable rule engine 104 and applies the selected rules to generate one or more customized offers 130 and/or customized actions 132 for the respective customer.

The customer data package can be loaded into the customer engagement module 106 by the package loader 402. Further, based on the loaded customer package, the customizable rule engine 104 generates customized rules 124. The customizable rule engine 104 evaluates the customized rules 124. Such rules 124 are used by the customer event management module 106 to generate one or more customized offers 130 and/or customized actions for the respective customer.

In some examples, the package loader 402 includes a package library (not shown) configured to maintain a set of loaded customer packages in the system. The package library assigns an identification number to each customer package. The identification number of the customer package facilitates efficient identification of the type of information stored in the customer package. In one example, the package library tracks the name of each fact (e.g., customer purchase data), number of parameters required for loading the fact into the customer event management module 106 along with the associated data.

The package library maintains the customer packages in the system 400, the hierarchy of customer packages and the facts stored in each customer package. A grammar is generated based on the type of information contained in the package library. The grammar includes relevant information regarding each customer package along with a list of facts. For each fact of the customer package, the number of parameters, the type of the customer package and the return type of the fact is included in the grammar. The operators allowed on each fact are also stored in the grammar, which can facilitate type checking while generating the rules.

Referring now to FIG. 5, an example package identification structure 500 of the customer packages loaded in an example system such as system of FIG. 4 is illustrated. As illustrated, each customer package is allotted with an identification number (generally represented by reference numeral 502) that is a 64 bit field. The identification number 502 is formed of a function of the package identification number of the parent customer package, index of the current customer package under the parent customer package and a level of the package.

As illustrated, the first 32 bits of the identification number represented by reference numeral 504 are reserved for a package hierarchy that supports about 7 levels of customer package hierarchy. The subsequent 12 bits (represented by reference numeral 506) represent the fact within the customer package. The fact identification number generation is a function of the package identification number and the fact number within the fact. In one example embodiment, there are about 7 levels of customer packages and about 15 child packages under any customer package. Here, about 4 bits are reserved for representing each child package identification numbers. The next 20 bits (represented by reference numeral 508) are reserved for future use.

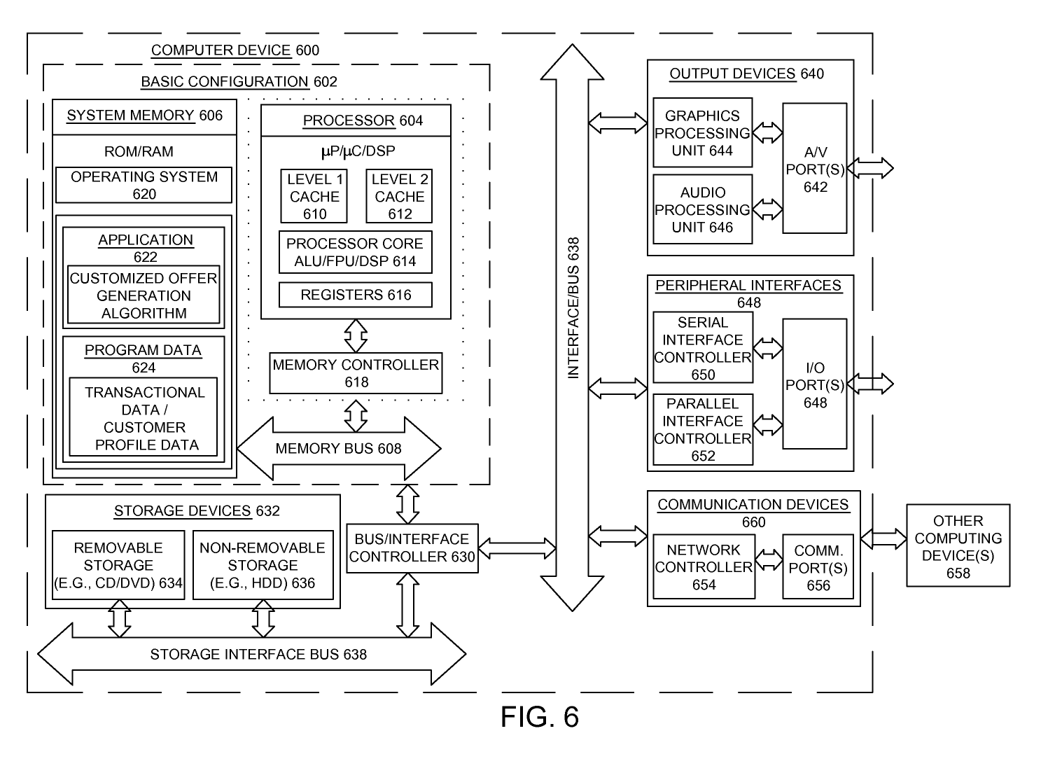

FIG. 6 is a block diagram illustrating an example computing device 600 that is arranged for managing customer engagements of a client with at least some embodiments of the present disclosure. In a very basic configuration 602, the computing device 600 typically includes one or more processors 604 and a system memory 606. A memory bus 608 may be used for communicating between processor 604 and system memory 606. The processor 604 includes a multi-core processor.

Depending on the desired configuration, processor 604 may be of any type including but not limited to a microprocessor (W), a microcontroller (μC), a digital signal processor (DSP), or any combination thereof. Processor 604 may include one more levels of caching, such as a level one cache 610 and a level two cache 612, two or more processor cores 614, and registers 616. An example processor core 614 may include an arithmetic logic unit (ALU), a floating point unit (FPU), a digital signal processor core (DSP Core), or any combination thereof. An example memory controller 618 may also be used with processor 604, or in some implementations memory controller 618 may be an internal part of processor 604. The processor 604 may include a location prediction module such as described above to facilitate prediction a location of a given memory address based upon a memory address distribution table of memory addresses stored by the on-chip caches of one or more of the processor cores 614.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. In some embodiments, application 622 may be arranged to operate with program data 624 on operating system 620. This described basic configuration 602 is illustrated in FIG. 6 by those components within the inner dashed line. Application 622 may include algorithm for generating customized offers targeted for plurality of customers for managing customer engagements. Program data 624 may include the transactional data and/or customer profile data of a plurality of customers of the client.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof.

Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652.

Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for managing customer engagements of a client, comprising:
an event tracker configured to track at least one of transactional data and customer profile data of a plurality of customers of the client;
a customizable rule engine configured to dynamically generate one or more customized rules using parameters associated with at least one of the transactional data and the customer profile data;
a customer event management module coupled to the event tracker and to the customizable rule engine, wherein the customer event management module is configured to analyze the transactional data and the customer profile data for each customer to select one or more applicable rules and to apply the selected rules to generate one or more customized offers for the respective customer; and
a customer engagement module configured to execute instructions for transmitting the one or more customized offers to the respective customer.

2. The system of claim 1, wherein the transactional data comprises data regarding purchases made by the customers, registration of the customers, purchase location of the customers, payment modes used by the customers, redemption of one or more offers provided to the customers by the client, or combinations thereof.

3. The system of claim 2, wherein the transactional data comprises data corresponding to transactions made by the plurality of customers at one or more point-of-sale terminals.

4. The system of claim 2, wherein the transactional data comprises data corresponding to transactions made by the plurality of customers using at least one online sale portal.

5. The system of claim 1, wherein the customer profile data comprises data associated with activities of the plurality of customers on internet-based social networks.

6. The system of claim 1, wherein the customer profile data comprises data related to age bands of the customers, location of the customers, names of the customers, client loyalty points of the customers, loyalty tiers of the customers, lifetime points of the customers, lifetime purchase value of the customers, number of days since last visit for the customers, number of total visits of the customers, average number of items bought per purchase by the customers, or combinations thereof.

7. The system of claim 1, wherein the one or more rules generated by the rule engine are configurable by a user of the system.

8. The system of claim 1, wherein the event tracker is further configured to group the transactional data and the customer profile data for each customer to form a customer data package of the respective customer.

9. The system of claim 1, wherein the event tracker is further configured to track attributes related to products and/or services offered by the client.

10. The system of claim 1, wherein the attributes comprise a category of a stock keeping unit (SKU), quantity of the SKU, average number of SKUs sold over a period of time, or combinations thereof.

11. The system of claim 1, wherein the one or more customized offers generated by the customer event management module comprise product offers, discount coupons, award points, or combinations thereof.

12. The system of claim 1, wherein the customized rule engine is further configured to identify one or more parameters to be tracked for the client.

13. The system of claim 12, wherein the customer engagement module is configured to transmit the one or more customized offers to the respective customer using short message service (sms), email, or combinations thereof.

14. The system of claim 1, wherein the customer engagement module is further configured to execute instructions to perform one or more customer actions.

15. The system of claim 14, wherein the one or more customer actions comprise posts on social networking sites, offer related messages, customer feedback on products and/or services of the client, push messages on a mobile device of the customers, loading offers onto customer devices, loading offers onto customer wallet, award of one or more loyalty points and offers, loyalty slab movement of the customers, or combinations thereof.

16. The system of claim 1, further comprising a first database configured to store the transactional data and the customer profile data of the plurality of customers.

17. The system of claim 1, further comprising a second database configured to store the one or more customized rules generated by the customizable rule engine.

18. The system of claim 1, wherein the event tracker is further configured to track the transactional data for each customer over a period of time.

19. The system of claim 1, wherein the customer event management module comprises a comparator configured to compare the tracked data with pre-determined thresholds to select one or more applicable rules for the respective customer.

20. The system of claim 1, wherein at least one of the event tracker, the customizable rule engine, customer event management module and the customer engagement module is a cloud-based resource.

21. A computer-implemented method for managing customer engagements of a client, the method comprising:
tracking at least one of transactional data and customer profile data of a plurality of customers of the client;
dynamically generating one or more customized rules using parameters associated with at least one of the transactional data and the customer profile data;
analyzing the transactional data and customer profile data of each customer to identify one or more applicable rules for the respective customer;
applying the identified one or more rules for generating one or more customized offers for the respective customer; and
transmitting the one or more customized offers to the respective customer.

22. The method of claim 21, wherein tracking at least one of the transactional data and the customer profile data further comprises obtaining data associated with offline transactions of the customers, online transactions of customers, internet-based social network based transactions, or combinations thereof.

23. The method of claim 21, wherein analyzing the transactional data and customer profile data of each customer comprises:
evaluating the transactions data and the customer profile data of each customer to determine if the respective customer qualifies for receiving offers from the client;
identifying the one or more applicable rules when the customer qualifies for receiving offers from the client.

24. The method of claim 21, wherein the one or more customized offers comprise product offers, discount coupons, award points, or combinations thereof.

25. The method of claim 21, wherein transmitting the one or more customized offers comprises sending the customized offers to the customer using short message service (sms), email, or combinations thereof.

26. A system for managing customer engagements of a client, comprising:
an event tracker configured to track at least one of transactional data and customer profile data of a plurality of customers of the client, wherein the event tracker is further configured to generate aggregates of one or more customer attributes for each customer;
a customizable rule engine configured to dynamically generate one or more customized rules using parameters associated with at least one of the transactional data, the customer profile data and the generated aggregates; and
a customer event management module coupled to the event tracker and to the customizable rule engine, wherein the customer event management module is configured to analyze the transactional data, the customer profile data, and the generated aggregates for each customer to select one or more applicable rules and to apply the selected rules to generate one or more customized offers and/or perform one or more customer actions for the respective customer.

27. The system of claim 26, further comprising a customer engagement module configured to execute instructions to perform one or more customer actions.

28. The system of claim 26, wherein the transactional data comprises data regarding purchases made by the customers, registration of the customers, purchase location of the customers, payment modes used by the customers, redemption of one or more offers provided to the customers by the client, or combinations thereof.

29. The system of claim 26, wherein the customer profile data comprises data related to age bands of the customers, location of the customers, names of the customers, client loyalty points of the customers, loyalty tiers of the customers, lifetime points of the customers, lifetime purchase value of the customers, number of days since last visit for the customers, number of total visits of the customers, average number of items bought per purchase by the customers, or combinations thereof.

30. The system of claim 26, wherein the one or more customer actions comprise posts on social networking sites, offer related messages, customer feedback on products and/or services of the client, push messages on a mobile device of the customers, loading offers onto customer devices, loading offers onto customer wallet, award of one or more loyalty points and offers, loyalty slab movement of the customers, or combinations thereof.

31. The system of claim 26, wherein the customer attributes comprise, but are not limited to, color of a purchased product, category/sub-category of a product, brand of a product, total spend on a product by the customer over a period of time, number of a product purchased by the customer, number of distinct instances when the customer purchased a product, or combinations thereof. total spend on a product by the customer over a period of time, number of a product purchased by the customer, number of distinct instances when the customer purchased a product, or combinations thereof.
